(19) United States
(12) Patent Application Publication
(10) Pub. No.: US 2011/0049094 A1
(43) Pub. Date: Mar. 3, 2011

(54) Method of manufacturing keycap structure, keypad structure, panel, and housing

(76) Inventor: Che-Tung Wu, Taoyuan (TW)

(21) Appl. No.: 12/626,675

(22) Filed: Nov. 26, 2009

(30) Foreign Application Priority Data
Sep. 2, 2009 (TW) 098129604

(51) Int. Cl. B44C 1/22

(52) U.S. Cl. 216/36

(57) ABSTRACT

A keycap structure is made by providing an elastomer laminate comprising an elastomer transparent layer and an elastomer colored layer, performing an etching process to locally remove the elastomer colored layer to form a pattern, bonding the elastomer laminate and a carrier to form a bonded structure, and combining the bonded structure and a keycap body. The keycap structure and the bonded structure may be utilized to make articles. The articles thereby have a leather-like soft touch and exquisite appearance.

### BACKGROUND OF THE INVENTION

1. Field of the Invention

The present invention relates to a keycap, a keypad structure, a panel and a housing, and particularly to a keycap, a keypad structure, a panel and a housing with a leather-like appearance and a leather-like touch feeling.

2. Description of the Prior Art

Due to the development of electronic technology, the demand for keypads is dramatically increasing in, for example, computers, calculators, mobile phones, instruments and the like. Touch panels are also increasingly used. An exquisite appearance and good touch feeling for consumer electronics, keypads or panels are further desired.

Japan Patent Application Publication No. 2009-21174 discloses a key sheet claimed to have a display portion having a leather-like soft touch feeling and a refined appearance, as shown in FIG. 1. The left side of FIG. 1 shows a schematic plan view of a key sheet 1. The key sheet 1 has a plurality of patterns for characters, numbers and symbols. The right side of FIG. 1 shows a schematic cross-sectional view taken along the line SA of the schematic plan view of the key sheet 1. The key sheet 1 includes a transparent surface layer 2 which is a resin layer and a print layer 3 printed on the inner side 2a of the transparent surface layer 2. The print layer 3 includes display portions 3a and background portions 3b and is combined with a transparent plate 5 through an adhesive layer 4. The print layer 3 has two portions formed by twice coating on the transparent surface layer 2. As shown in the drawing, since the print layer 3 only serves to show patterns and colors, it works even if its thickness is just sufficient to show the patterns and colors. However, the transparent surface layer 2 requires a certain strength, and, as a result, it tends to be three times or more the thickness of the print layer 3.

Due to consistent desire for keypads with an good touch feeling and an exquisite appearance, there is still a need for a novel method to make a keycap or keypad structure with a leather-like soft touch feeling and an exquisite appearance.

### SUMMARY OF THE INVENTION

An objective of the present invention is to provide a method of making a keycap structure to make a keycap structure having a leather-like soft touch feeling and an exquisite appearance.

The method of making a keycap structure according to the present invention includes steps as follows. An elastomer laminate is provided. The elastomer laminate includes an elastomer transparent layer and an elastomer colored layer. An etching process is performed on the elastomer laminate to partially remove the elastomer colored layer, thereby to form a pattern on the elastomer laminate. The elastomer laminate and a carrier are bonded to each other to form a bonded structure. The bonded structure is combined with a keycap body.

In another aspect of the present invention, another objective of the present invention is to provide a method of making a keypad structure, which includes steps as follows. An elastomer laminate is provided. The elastomer laminate comprises an elastomer transparent layer and an elastomer colored layer. An etching process is performed on the elastomer laminate to partially remove the elastomer colored layer, thereby to form a pattern on the elastomer laminate. The elastomer laminate and a carrier are bonded to each other to form a bonded structure. The bonded structure is combined with a keycap body to form a keycap structure. The keycap structure and a keypad circuit board module are assembled.

In further another aspect of the present invention, further another objective of the present invention is to provide a method of making a housing with a decorating structure, which includes steps as follows. An elastomer laminate is provided. The elastomer laminate includes an elastomer transparent layer and an elastomer colored layer. An etching process is performed on the elastomer laminate to partially remove the elastomer colored layer, thereby to form a pattern on the elastomer laminate. The elastomer laminate and a carrier are bonded to each other to form a bonded structure. The bonded structure is combined with a housing, thereby allowing the bonded structure to adhere to the exterior of the housing.

In still further another aspect of the present invention, still further another objective of the present invention is to provide a method of making a panel with a leather appearance and a leather touch feeling, which included steps as follows. An elastomer laminate is provided. The elastomer laminate includes an elastomer transparent layer and an elastomer colored layer. An etching process is performed on the elastomer laminate to partially remove the elastomer colored layer, thereby to form a pattern on the elastomer laminate. The elastomer laminate and a carrier are bonded together to form a bonded structure. The bonded structure is combined with a panel, thereby to allow the panel to have the leather-like appearance and the leather-like touch feeling.

The keycap structure, the keypad structure, the housing with a decorating structure or the panel with a leather-like appearance and a leather-like touch feeling made utilizing the method according to the present invention has a soft touch feeling. Surface thereof is smooth and has not any recess or pit although a pattern is present. When the backlight of the keypad structure is turned off, the pattern is not very apparent and seems to be hidden or disappear. When the backlight is turned on, the pattern can be clearly sighted. It may be referred to as “Hidden Til Lit”.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic cross-sectional view illustrating a conventional key sheet;

FIG. 2 is a flow chart illustrating a method according to an embodiment of the present invention;

FIG. 3 is a schematic exploded view illustrating an elastomer laminate in a method according to an embodiment of the present invention;

FIG. 4 is a schematic cross-sectional view illustrating a bonded structure in a method according to an embodiment of the present invention;

FIG. 5 is a schematic exploded view illustrating a keypad made in a method of making a keypad structure according to an embodiment of the present invention;

FIG. 6 is a schematic cross-sectional view illustrating a keypad made in a method of making a keypad structure according to an embodiment of the present invention;

FIG. 7 is a schematic perspective view illustrating a force feedback module utilized in a method of making a keypad structure according to an embodiment of the present invention;

FIG. 8 and FIG. 9 are schematic cross-sectional views illustrating a certain force feedback module disposed in a method according to an embodiment of the present invention;

FIG. 10 is a schematic cross-sectional view illustrating a panel made by a method of making a panel according to an embodiment of the present invention;

FIG. 11 is a schematic cross-sectional view illustrating a housing with a decorating structure made by a method of making a housing with a decorating structure according to an embodiment of the present invention; and

FIG. 12 is a schematic perspective diagram illustrating an application of a method of the present invention to a notebook computer.

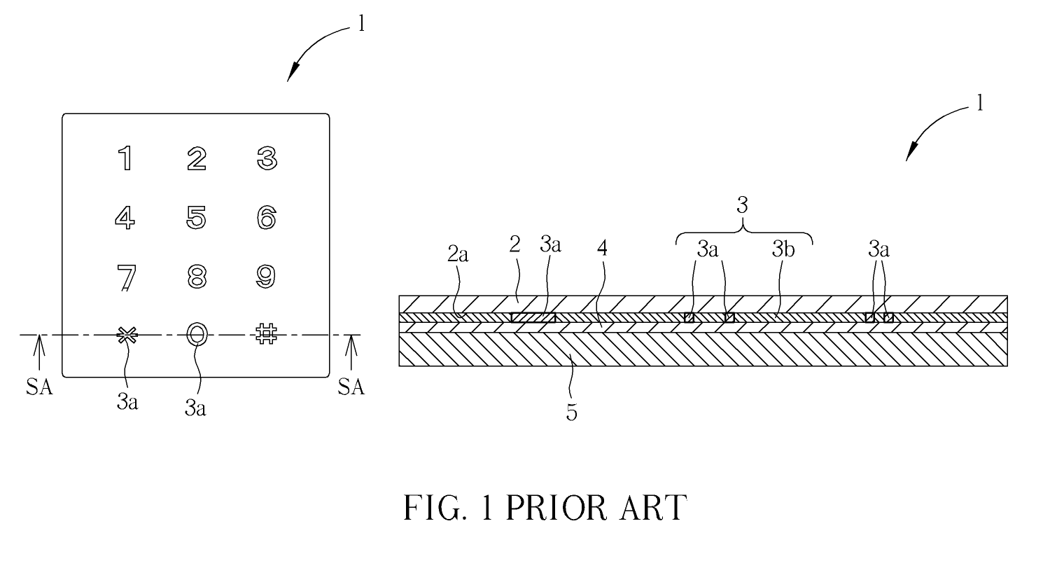

### DETAILED DESCRIPTION

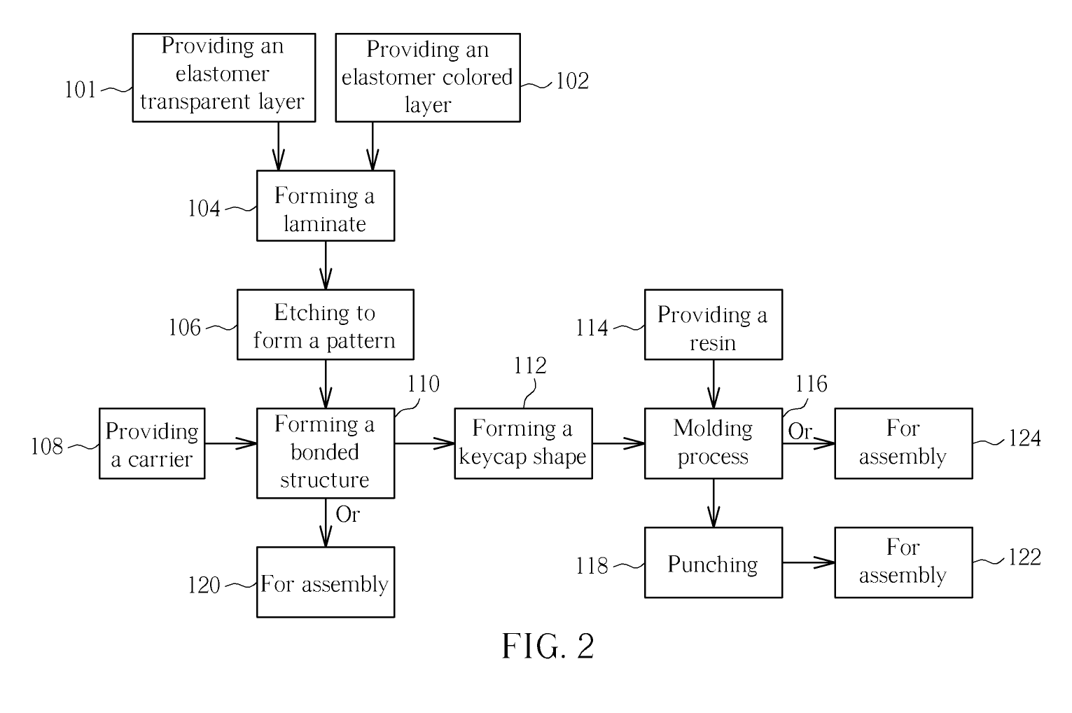

FIG. 2 is a flow chart illustrating a method according to an embodiment of the present invention. First, an elastomer transparent layer and an elastomer colored layer are provided in steps 101 and 102, respectively, and both are laminated to form an elastomer laminate in a step 104. The elastomer laminate including such two elastomer layers laminated together may be formed using a hot rolling process to adhere the elastomer transparent layer and the elastomer colored layer both as a film to each other, by rolling or calendaring one melt elastomer material on the other elastomer layer as a film, or by rolling or calendaring two melt elastomer material. The elastomer colored layer is an elastomer layer which is colored by addition of a colorant, such as dye, pigment, and the like, or other process which may color the elastomer, for example, to make the elastomer layer black. The elastomer transparent layer covers the elastomer colored layer; while the entire elastomer laminate expresses the color of the elastomer colored layer, such as black color. Preferably, the elastomer laminate may be further textured by, for example, pressing (or also referred to as embossing) to have an appearance or touch feeling of a leather-liked texture. The texturing process may be performed when the lamination is performed.

Thereafter, in a step 106, an etching process is performed on the elastomer laminate to partially remove the elastomer colored layer in accordance with a desired pattern. The elastomer transparent layer is substantially not etched or etched through. In such situation, the elastomer laminate can have a pattern thereon even though only the elastomer colored layer, not the elastomer transparent layer, is etched to have a hollowed pattern. The pattern may be as desired, such as number, letter, symbol, figure, decoration and the like. When the elastomer laminate is used in a keypad, the location of the pattern may be corresponding to the position of the keycap. The etching process may utilize a laser engraving process, a physical etching process or a chemical etching process. The laser engraving process is preferred since a proper laser energy and a cutting position may be well set to precisely partially remove the elastomer colored layer. A very refined pattern, such as a tiny dotted hollowed pattern, may be obtained by laser engraving. The elastomer transparent layer may work as a protection layer. It is substantially not required to be etched; however, since it will be exposed to the etching environment after the elastomer colored layer is partially removed, the slight removal of the elastomer transparent layer is allowed in the present invention.

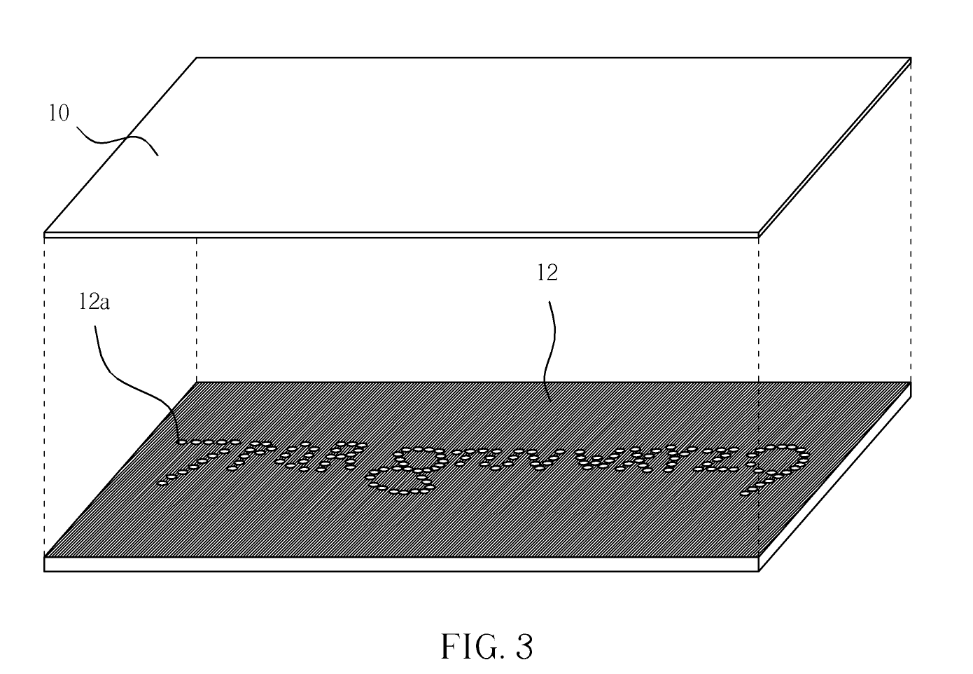

The elastomer laminate in the present invention is preferably made by directly adhering the elastomer transparent layer and the elastomer colored layer to each other by means of melt, not through a heterogeneous adhesive, thereby to possess a homogeneous touch feeling of the elastomer per se. Preferably, the elastomer transparent layer is thinner than elastomer colored layer. For example, the elastomer transparent layer has a thickness being a third of the thickness of the elastomer colored layer, but not limited thereto. For some locations of the elastomer laminate, where the elastomer colored layer is partially removed but the elastomer transparent layer is left, a smooth touch feeling of the elastomer transparent layer is still remains. Furthermore, since the elastomer transparent layer is relatively thin, even the elastomer colored layer is relatively thick, the distance of the elastomer colored layer from viewers can be felt not so far. Furthermore, by such double-layered design, especially when the colored layer is imparted with a tiny dotted hollowed pattern, as illustrated by the exploded view shown in FIG. 3, in which the elastomer transparent layer 10 and the elastomer colored layer 12 are laminated together, the elastomer colored layer has a pattern including a tiny dotted hollowed pattern 12a. The pattern formed by the hollowed pattern on the colored layer can be apparently or clearly sighted when a backlight is on. The pattern is not very apparent or obvious when the backlight is off, and such that the pattern has a hiding effect and renders an exquisite appearance to the keycap structure.

It is preferred to use polyurethane (PU) as the elastomer material in the present invention because artificial leather formed from PU possesses soft touch feeling.

Regarding forming a laser engraved pattern on a single layer of artificial leather, after the artificial leather is partially removed using for example the laser engraving method to form a pattern, resulting in holds. If it is touched, it will be felt as not smooth, and the holes tend to receive dirt. After a period of time, the holes may be stuffed up and the pattern will seems to disappear. The method of the present invention has not such disadvantage.

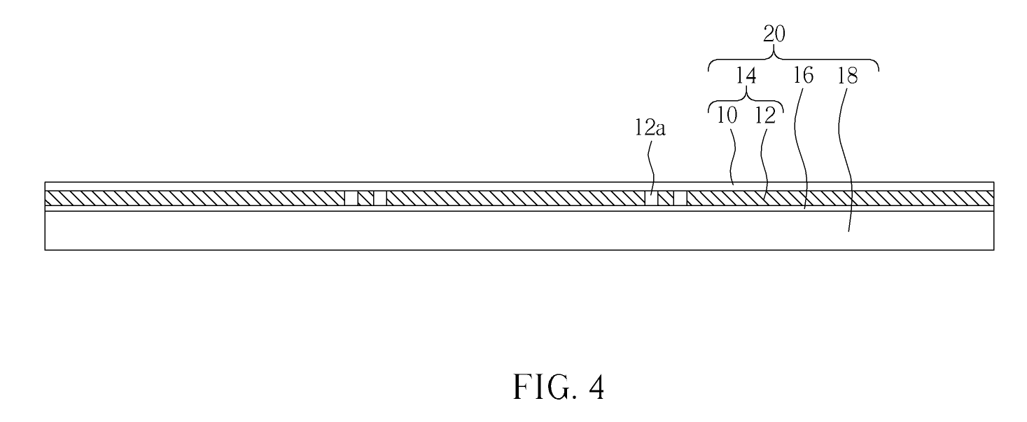

Thereafter, a step 110 is performed to combine the carrier provided in a step 108 with the etched laminate having a pattern through adhesion by for example a transparent or translucent adhesive agent or tape to form a bonded structure, as shown in FIG. 4. The elastomer transparent layer 10 and the elastomer colored layer 12 are laminated to be as the elastomer laminate 14. The elastomer colored layer 12 has a pattern formed from the hollowed pattern 12a after being laser engraved. The elastomer laminate 14 and a carrier 18 are bonded together through an adhesive layer 16 to form a bonded structure 20.

The carrier may be various, such as film material. The carrier is utilized to support the elastomer laminate and enhance the strength, which will benefit the following processing steps. The film material may be for example a transparent or translucent plastic film. For example, polycarbonate (PC) film, polyethylene terephthalate (PET) film or polystyrene (PS) is preferred.

A print layer may be further formed on the elastomer laminate at the elastomer colored layer side or on the carrier at either side using for example a printing process, thereby to provide the pattern with color. Preferably, the print layer is disposed between the elastomer laminate and the carrier, so as to protect the color of the print layer after the elastomer laminate and the carrier are formed into a bonded structure.

After the step 110, the bonded structure obtained may be utilized in the formation of keycaps, panels (especially touch panel), or housings of instruments or devices to be an exterior thereof. The combination of the bonded structure with the keycap bodies, panels, or housings may be accomplished in various ways, for example, by an insert-molding decoration (IMD) process, such as an insert-molding by forming (IMF) process including a molding process or an insert-molding by labeling (IML) process including attaching step, or by an insert-molding bonding (IM Bonding) process. Some embodiments are described as follows.

The IMF process is equivalent to a step 112 followed by a step 116 as shown in the flow chart of FIG. 2. That is, the bonded structure is formed into a shape of keycap or housing. This may be accomplished by for example a thermoforming process. Thereafter, the bonded structure having the shape of the keycap or the housing is placed within a mold cavity having the shape of the keycap or the housing. A melt resin provided in a step 114 is injected to the bonded structure having the shape of the keycap or the housing to perform a molding process, thereby to fill the bonded structure having the shape of the keycap or the housing with the resin material (i.e. step 116) and form a keycap or housing with a leather-like appearance after taken out from the mold.

Alternatively, the IML process is performed as follows. The bonded structure is placed within a mold cavity having a shape of a keycap or housing to perform a molding process to fill the bonded structure having the keycap shape with a resin material to form a keycap or housing with a leather-like appearance after taken out from the mold.

Alternatively, a keycap body having a keycap shape or a housing is provided, and the bonded structure is bonded or attached to the keycap body or housing in accordance with the contour of the keycap body or housing to form a keycap or housing with a leather-like appearance.

Alternatively, a keycap body having a plate shape or a panel is provided. The bonded structure may be bonded to the keycap body or the panel. The panel may be a touch panel module.

The keycap body may be formed of for example resin. The resin may be for example light-curable resin, which is transparent or light-transmissive after being cured. The keycap body may be integrally formed with a plunger.

The material for the housing is chosen in accordance with the design of the instrument or the device. It may be resin, and particularly light-curable resin, which is transparent or light-transmissive after being cured. Or, it may be metal, and especially a hollowed metal sheet, such that after it is bonded with the aforesaid bonded structure, it expresses the pattern on the elastomer laminate when a backlight is on.

The keycap is further used in a keypad structure. The aforesaid keycap may be presented as a whole sheet which may include a plurality of keycap units. The elastomer laminate has a pattern corresponding to each position for keycap units. As desired, each keycap unit may be punched out (in a step 118) to be separated and for assembly to form a keypad structure in a step 122. Or, as desired or designed, the whole sheet having a plurality of keycap units may be used for assembly in step 124 without punching for separation.

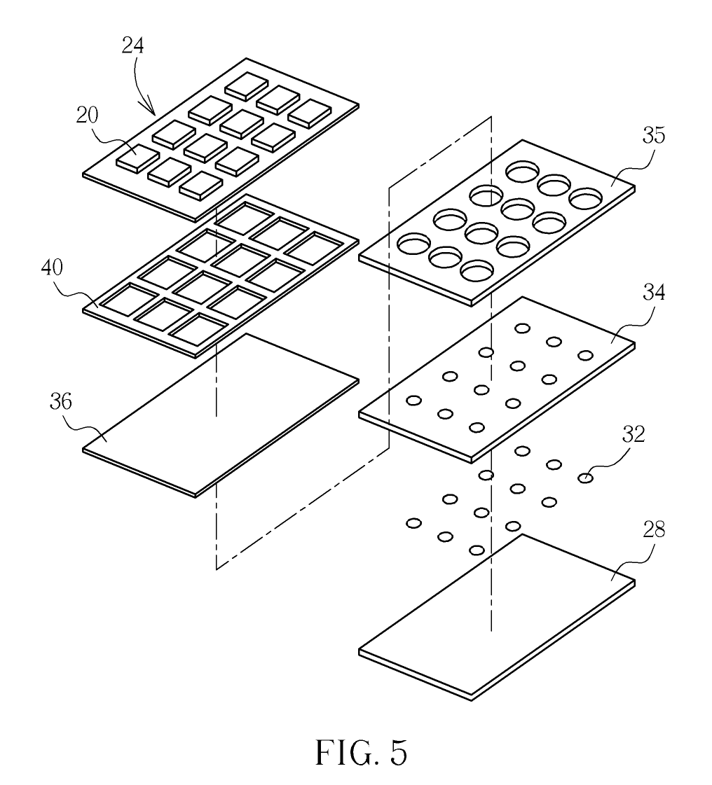

Referring to FIG. 5 illustrating a keypad made in a method of making a keypad structure according to an embodiment of the present invention, a whole piece of keycap structure 24 having a plurality of connected keycaps obtained as aforesaid is further combined with a keypad circuit board module to make a keypad structure in the step 122 or 124. In this embodiment, the keycap structure 24 includes a plurality of keycaps connected as a whole piece. Each keycap may include the aforesaid bonded structure 20 and the keycap body 22. The keypad circuit board module may includes, for example, a circuit board 28 including electrical connection sites disposed thereon; a plurality of metal domes 32 disposed on the circuit board 28 at a position above the electrical connection sites, such that when the metal dome 32 is pressed, the metal dome 32 is electrically connected to the electrical connection site; and a metal dome adhesive sheet 34 for fixing the metal dome 32 on the circuit board 28. The circuit board may be a printed circuit board, and preferably a flexible print circuit board.

An elastomer base 36 may be further bonded between the keycap structure 24 and the keypad circuit board module. The elastomer base 36 may further formed integrally with a plunger. The location of the plunger corresponds to the position of the metal dome 32. The combination of the keycap structure 24, the elastomer base 36 and the keypad circuit board module may be accomplished through an adhesive tape 40 or adhesive agent. The elastomer base is preferably, for example, a rubber or silicon rubber base, and may be transparent or light-transmissive as desired. A guide light plate 35, such as PC guide light plate may be further disposed between the elastomer base 36 and the metal dome adhesive sheet 34. The guide light plate 35 has portions corresponding to the locations of the plungers and also the metal dome 32 are hollowed for the plungers to bond with the metal domes 32 through a metal dome adhesive sheet 34. Or the elastomer base 36 may be further allowed to have a function of guide light plate.

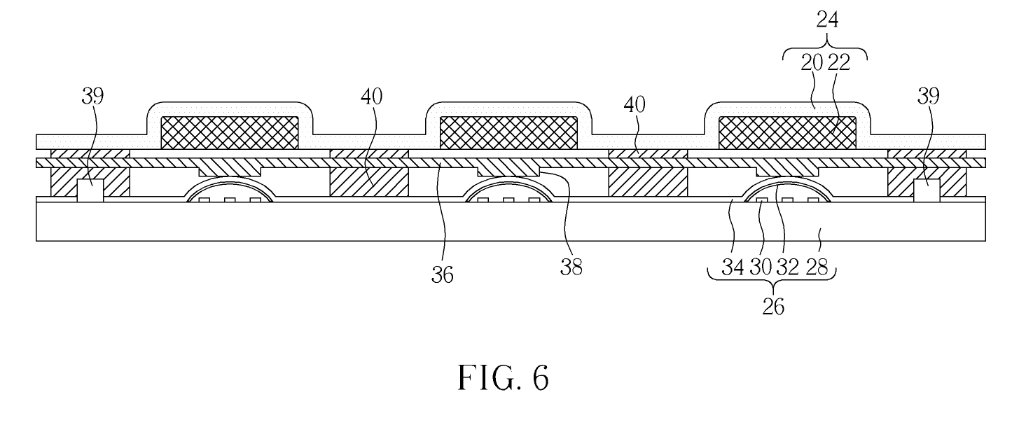

A light source may be included in the keypad structure to serve as a backlight of the keycap. The light source may be for example a light-emitting diode (LED) which may be electrically connected with a circuit board or operated independently. FIG. 6 indicating a schematic cross sectional view shows LED 39 disposed on the circuit board 28 of the keypad circuit board module 26.

Furthermore, a force feedback module or a touch panel may be further combined between the keycap structure 24 and the elastomer base 36. If both the touch panel and the force feedback module are assembled, it is preferred that the force feedback module is nearer than the touch panel to the keycap, such that the haptic feedback to users can be relatively obvious. Alternatively, the force feedback module may be combined with a touch control electric circuit of a touch panel, to allow the force feedback module also has a touch function. It is preferred that the touch panel and the force feedback module are transparent or light-transmissive, so as not to limit the location of the light source of the backlight for the keycaps; and accordingly the light source can be disposed on the circuit board.

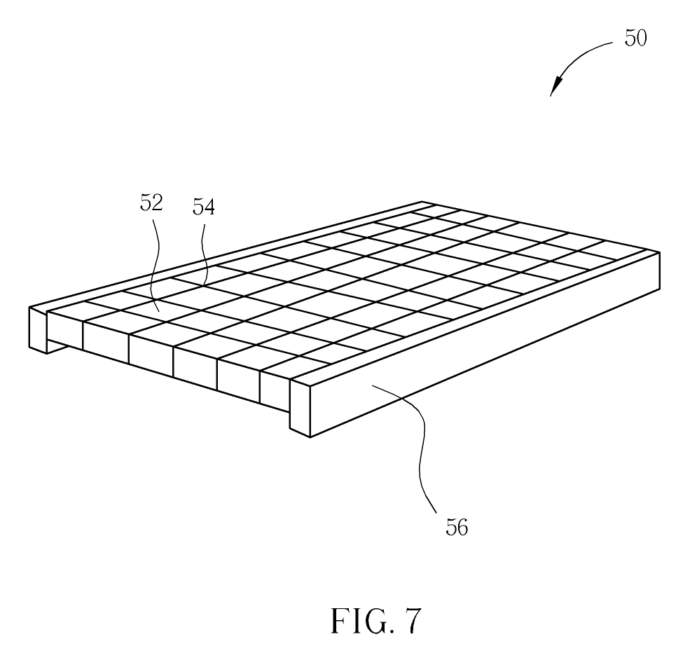

A force feedback module includes a haptic feedback unit and a feedback actuation unit. The haptic feedback unit is activated by the feedback actuation unit to feed back users touch feeling when it is pressed. The feedback actuation unit activates the haptic feedback unit to feed back users touch feeling when it is pressed. The force feedback module may be for example one disclosed in the U.S. Pat. Application Publication No. 2009/0002328A1, which is incorporated herein by reference. Referring to FIG. 7, the force feedback module 50 includes an array or a grid of haptic cells 52 for serving as haptic feedback units separated from each other by borders 54. The force feedback module 50 further includes circuit blocks 56, which are configured to perform various functions such as maintaining power supplies and transmitting control signals to haptic cells 52 and serves as a feedback actuation unit. Since a grid of the haptic cells all serve to feed back with respect to the press from users, a haptic feeling can be effectively and immediately fed back to the location pressed by a finger or fingers, even in a multi-touch situation.

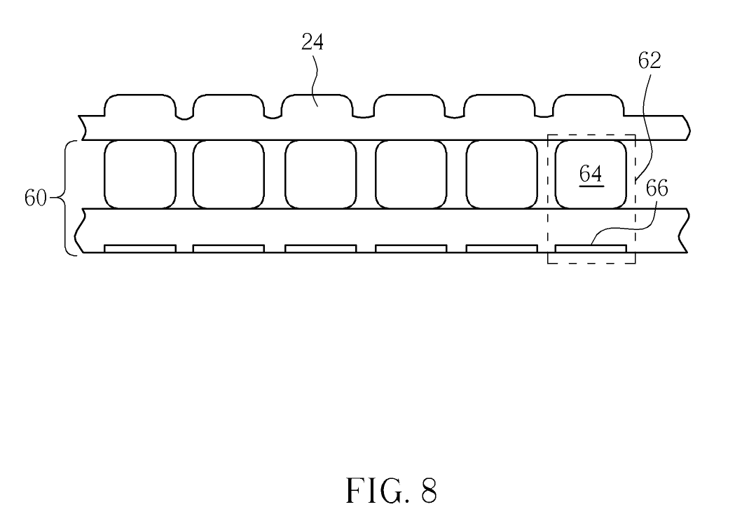

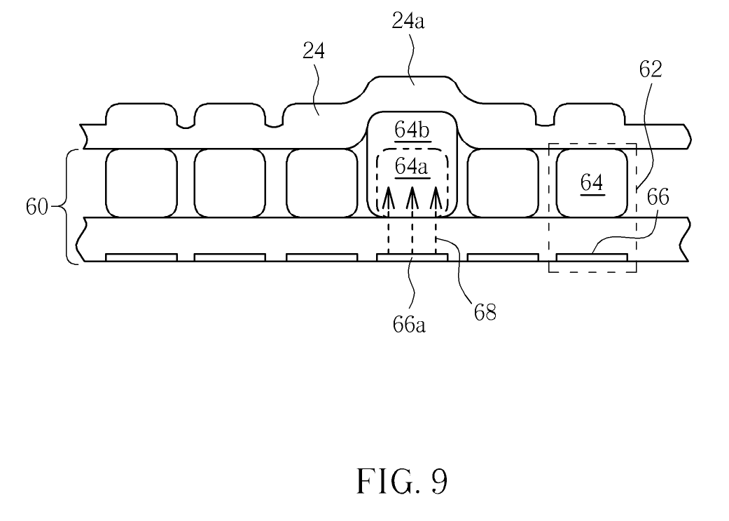

FIGS. 8 and 9 further illustrate a certain force feedback module disposed in a keypad structure according to a certain embodiment. As shown in FIGS. 8 and 9, the force feedback module 60 is disposed beneath the keycap structure 24. The force feedback module 60 includes a grid of a plurality of cells 62. Each cell 62 includes a fluid pocket 64 as a haptic feedback unit and an activator 66 as a feedback actuation unit. The fluid pocket contains thermal fluid which is thermally expansible. For example, as shown in FIG. 9, after a user presses the keycap structure 24a, the pressure is delivered through the fluid pocket 64a to the activator 66a. The activator 66a receives the pressure and actuate an electric power to heat (68) the fluid pocket 64a. Accordingly, the fluid pocket 64a expands to become the fluid pocket 64b, and this makes the user feel a force feedback after the pressing.

An elastomer base may be disposed beneath the force feedback module. The elastomer base may include a plunger. Thereafter, a keypad circuit board module may be disposed to obtain a keypad structure.

The force feedback module may be combined with the touch unit of a touch panel. For example, a feedback actuation unit is allowed to include the control mechanism of the touching panel to have a touch control function.

Alternatively, the keypad structures shown in FIGS. 5 and 6 are embodiments of non-separated keys; however, the assembly of separated keys obtained through punching out each unit in a keycap shape should be also realized.

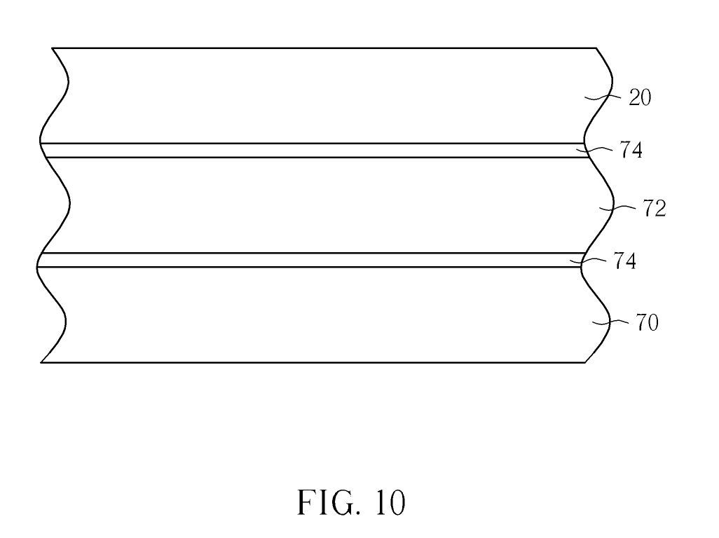

In another aspect of the present invention, after the step 110 shown in FIG. 2 to form the bonded structure, referring to FIG. 10, a step 120 may be alternatively perform to assembly the bonded structure 20 and a touch panel module 70, thereby to make the touch panel module to have a leather-like appearance and touch feeling. A force feedback module 72 may be further disposed between the bonded structure 20 and the touch panel module 70. An adhesive tape 74 or adhesive agent may be used to combine them. Alternatively, the touch panel module and the force feedback module may be integrated to form into a device.

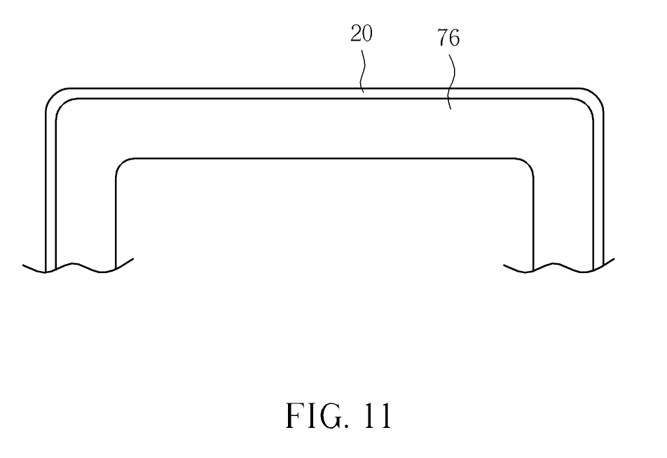

FIG. 11 illustrates a housing with a decorating structure made by a method according to an embodiment. The bonded structure is attached on the housing 76.

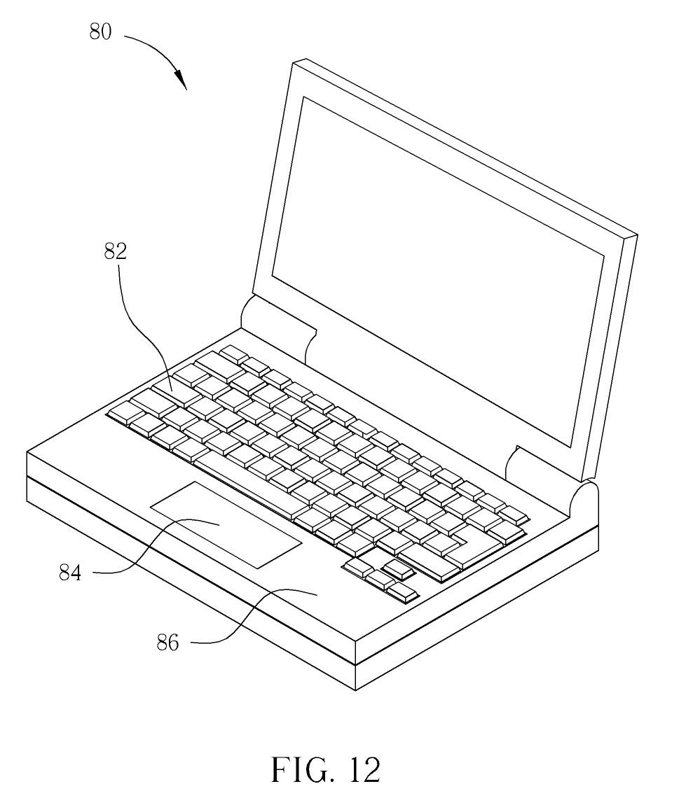

The method according to the present invention may be widely utilized in, for example, mobile phones, notebook computers, electronic products and the like. FIG. 12 illustrates a schematic perspective diagram of a notebook computer. The method according to the present invention may be utilized to make for example the keycaps or keypad structure 82, the first touch panel 84 or the second touch panel 86 of the notebook computer 80.

Those skilled in the art will readily observe that numerous modifications and alterations of the device and method may be made while retaining the teachings of the invention.

What is claimed is:

1. A method of making a keycap structure, comprising:
providing an elastomer laminate comprising an elastomer transparent layer and an elastomer colored layer;
performing an etching process on the elastomer laminate to partially remove the elastomer colored layer, thereby to form a pattern on the elastomer laminate;
bonding the elastomer laminate and a carrier to form a bonded structure; and
combining the bonded structure with a keycap body.

2. The method of claim 1, wherein the elastomer laminate is formed through laminating and pressing the elastomer transparent layer and the elastomer colored layer, thereby to have a texture appearance and a touch feeling corresponding to the texture.

3. The method of claim 1, wherein the etching process comprises a laser engraving process.

4. The method of claim 1, wherein the etching process comprises a physical etching process or a chemical etching process.

5. The method of claim 1, wherein combining the bonded structure with the keycap body comprises:
forming the bonded structure into a keycap shape;
placing the bonded structure having the keycap shape within a mold cavity having the keycap shape; and
performing a molding process to fill the bonded structure having the keycap shape with a keycap body material to form a combined structure of the bonded structure and the keycap body.

6. The method of claim 1, wherein combining the bonded structure with the keycap body comprises:
placing the bonded structure over a mold cavity having a keycap shape; and
performing a molding process to fill the molding cavity having the keycap shape with a keycap body material to form a combined structure of the bonded structure and the keycap body.

7. The method of claim 1, wherein combining the bonded structure with the keycap body comprises:
providing a keycap body having a keycap shape; and
bonding the bonded structure to the keycap body having the keycap shape in accordance with the keycap shape.

8. The method of claim 1, wherein combining the bonded structure with the keycap body comprises:
providing a keycap body having a plate shape; and
bonding the bonded structure to the keycap body having the plate shape.

9. The method of claim 1, wherein the keycap body further comprises a plunger.

10. The method of claim 1, further comprising forming a print layer on the elastomer laminate at the elastomer colored layer side or on the carrier at a side thereof, thereby to provide the pattern with color.

11. The method of claim 1, wherein the elastomer laminate comprises a polyurethane transparent layer and a polyurethane colored layer both laminated together.

12. A method of making a keypad structure, comprising:
providing an elastomer laminate comprising an elastomer transparent layer and an elastomer colored layer;
performing an etching process on the elastomer laminate to partially remove the elastomer colored layer, thereby to form a pattern on the elastomer laminate;
bonding the elastomer laminate and a carrier to form a bonded structure;
combining the bonded structure with a keycap body to form a keycap structure; and
assembling the keycap structure and a keypad circuit board module.

13. The method of claim 12, further comprising forming a print layer on the elastomer laminate at the elastomer colored layer side or on the carrier at a side thereof, thereby to provide the pattern with color.

14. The method of claim 12, wherein the keypad circuit board module comprises:
a circuit board comprising a electrical connection sites;
a metal dome disposed on the circuit board and above the electrical connection sites, wherein, when the metal dome is pressed, the metal dome is electrically connected to the electrical connection site; and
a metal dome adhesive sheet for fixing the metal dome on the circuit board.

15. The method of claim 12, further comprising bonding an elastomer base between the keycap structure and the keypad circuit board module.

16. The method of claim 15, further comprising combining a touch panel between the keycap structure and the elastomer base.

17. The method of claim 15, further comprising disposing a haptic feedback module between the keycap structure and the elastomer base, wherein the haptic feedback module comprises:
a haptic feedback unit under the keycap structure for providing haptic feedback upon being pressed; and
a feedback actuation unit for activating the haptic feedback unit when the haptic feedback unit is pressed.

18. The method of claim 12, further comprising disposing a light source or a light guide plate under the keycap structure for serving as a backlight of the keycap structure.

19. The method of claim 12, wherein the elastomer laminate comprises a polyurethane transparent layer and a polyurethane colored layer both laminated together.

20. A method of making a housing with a decorating structure, comprising:
providing an elastomer laminate comprising an elastomer transparent layer and an elastomer colored layer;
performing an etching process on the elastomer laminate to partially remove the elastomer colored layer, thereby to form a pattern on the elastomer laminate;
bonding the elastomer laminate and a carrier to form a bonded structure; and
combining the bonded structure with a housing, thereby allowing the bonded structure to adhere to the exterior of the housing.

21. The method of claim 20, further comprising forming a print layer on the elastomer laminate at the elastomer colored layer side or on the carrier at a side thereof, thereby to provide the pattern with color.

22. The method of claim 20, wherein combining the bonded structure with the housing comprises:
forming the bonded structure into a shape of the housing;
placing the bonded structure having the shape of the housing within a mold cavity having the shape of the housing; and
performing a molding process to fill the bonded structure having the shape of the housing with a housing material, thereby allowing the bonded structure to adhere to the exterior of the housing.

23. The method of claim 20, wherein combining the bonded structure with the housing comprises:
placing the bonded structure on a mold cavity having the shape of the housing; and
performing a molding process to fill the molding cavity having the shape of the housing with a housing material, thereby allowing the bonded structure to adhere to the exterior of the housing.

24. The method of claim 20, wherein combining the bonded structure with the housing comprises:
providing the housing; and
bonding the bonded structure to an exterior of the housing in accordance with the shape of the housing.

25. The method of claim 24, wherein the housing is in a plate shape.

26. The method of claim. 20, wherein the elastomer laminate comprises a polyurethane transparent layer and a polyurethane colored layer both laminated together.

27. A method of making a panel with a leather-like appearance and a leather-like touch feeling, comprising:
providing an elastomer laminate comprising an elastomer transparent layer and an elastomer colored layer;
performing an etching process on the elastomer laminate to partially remove the elastomer colored layer, thereby to form a pattern on the elastomer laminate;
bonding the elastomer laminate and a carrier to form a bonded structure; and
combining the bonded structure with a panel, thereby to allow the panel to have the leather appearance and the leather touch feeling.

28. The method of claim 27, further comprising forming a print layer on the elastomer laminate at the elastomer colored layer side or on the carrier at a side thereof, thereby to provide the pattern with color.

29. The method of claim 27, wherein the panel comprises a touch panel module.

30. The method of claim 29, further comprising disposing a haptic feedback module between the bonded structure and the touch panel module, wherein the haptic feedback module comprises:
an insulation film;
a haptic feedback unit under the insulation film for providing haptic feedback upon being pressed; and
a feedback actuation unit for activating the haptic feedback unit when the haptic feedback unit is pressed.

31. The method of claim. 27, wherein the elastomer laminate comprises a polyurethane transparent layer and a polyurethane colored layer both laminated together.
